(19) United States
(12) Patent Application Publication
(10) Pub. No.: US 2012/0172514 A1
(43) Pub. Date: Jul. 5, 2012

(54) THERMOPLASTIC COMPOSITIONS FOR SHEET MATERIALS HAVING IMPROVED TENSILE PROPERTIES

(76) Inventors: Russell F. Ross, Atlanta, GA (US); Wing-Chak Ng, Suwanee, GA (US); John Gavin MacDonald, Decatur, GA (US)

(21) Appl. No.: 12/983,030

(22) Filed: Dec. 31, 2010

(51) Int. Cl. C08K 3/34; C08L 23/12; B82Y 30/00

(52) U.S. Cl. 524/445; 524/528; 977/773; 977/831

(57) ABSTRACT

Disclosed is a thermoplastic composition suitable for forming sheet materials with improved tensile properties. The thermoplastic composition includes from about 1 to about 98 weight percent of a fiber-forming or film-forming polymer, from about 1 to about 98 weight percent of a low melt flow rate polymer having a melt flow rate less than 20 grams per 10 minutes, and from about 0.1 to about 10 weight percent of nanoparticles. The nanoparticles may be cylindrical nanoparticles having an average aspect ratio greater than about 1 and less than about 500.

### BACKGROUND OF THE INVENTION

Sheet materials, such as fibrous fabrics and films, are useful for a wide variety of applications, such as in absorbent products, wipers, towels, industrial garments, medical garments, medical drapes, sterile wraps, and so forth. Sheet materials such as these may be produced from various thermoplastic compositions, the composition of which at least in part determines the sheet material's tensile properties such as, for example, peak load, elongation, and absorbed energy. For example, strength (as indicated by peak load) and toughness (as indicated by absorbed energy) are important properties for sheet materials, as there is generally a direct relationship between the strength and toughness of a sheet material and a basis weight of the sheet material necessary to achieve particular strength and toughness targets required for a particular use. As such, tensile property improvements in sheet materials offer an opportunity to reduce the basis weight to achieve a certain tensile property target. Reduced basis weights are desirable in that reduced basis weight generally translates to reduced costs.

Accordingly, there is a need for thermoplastic compositions useful for making sheet materials that demonstrate improved tensile properties.

### SUMMARY OF THE INVENTION

The aforesaid needs are fulfilled and the problems experienced by those skilled in the art overcome by an embodiment of the present invention that is generally directed to a thermoplastic composition suitable for making sheet materials, the thermoplastic composition including from about 1 wt. % to about 98 wt. % of a fiber forming or film forming polymer, from about 1 wt. % to about 98 wt. % of a high molecular weight/low melt flow polymer, and from about 0.1 wt. % to about 10 wt. % nanoparticles. In one aspect, the nanoparticles may be cylindrical nanoparticles.

In another embodiment, the present invention is directed to a fibrous web including having improved tensile properties. The fibrous web is made of continuous fibers of a thermoplastic polymeric composition including from about 1 wt. % to about 98 wt. % of a fiber forming polymer, from about 1 wt. % to about 98 wt. % of a high molecular weight/low melt flow polymer, and from about 0.1 wt. % to about 10 wt. % nanoparticles. The fibrous web may have a geometric mean tensile strength from about 1% to about 50% greater than a similar fiber made from the fiber forming polymer.

Other features and aspects of the present invention are discussed in greater detail below.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

### Test Methods

Melt Flow Rate

The melt flow rate is the weight of a polymer (in grams) that may be forced through an extrusion rheometer orifice (0.0825 inch diameter) when subjected to a force of 2160 grams in 10 minutes at a certain temperature (e.g., 190° C. or 230° C.). As used herein, the melt flow rates are measured in accordance with ASTM Test Method D1238-E at 230° C.

Tensile Properties

The strip tensile property values were determined in substantial accordance with ASTM Standard D-5034. Specifically, a sample was cut or otherwise provided with size dimensions that measured 3 inches (76.2 millimeters) (width)×6 inches (152.4 millimeters) (length). A constant-rate-of-extension type of tensile tester was employed. The tensile testing system was a Sintech Tensile Tester, which is available from MTS Corp. of Eden Prairie, Minn., although an equivalent may be used. The tensile tester was equipped with TESTWORKS 4.08B software from MTS Corporation to support the testing, though an equivalent software program may be used. An appropriate load cell was selected so that the tested value fell within the range of 10-90% of the full scale load. The sample was held between grips having a front and back face measuring 3 inch (76.2 millimeters)×3 inches (76 millimeters). The grip faces were rubberized, and the longer dimension of the grip was perpendicular to the direction of pull. The grip pressure was pneumatically maintained at a pressure of 60 to 80 pounds per square inch. The tensile test was run at a 12 inches per minute rate with a gauge length of 4 inches and a break sensitivity of 40%. Three samples were tested along the machine direction (“MD”) and three samples were tested along the cross direction (“CD”). The ultimate tensile strength (“peak load”), peak elongation (elongation percent at peak load as percentage of initial gage length), and energy absorbed (area under the load-elongation curve from the origin to the point of rupture) were recorded. Geometric Mean Tensile (GMT) is defined as the square root of the product of the MD and CD peak loads.

### DETAILED DESCRIPTION

Generally speaking, the present invention is directed to a thermoplastic composition suitable for forming sheet materials. The thermoplastic composition includes from about 1 to about 98 weight percent of a fiber-forming or film-forming polymer, from about 1 to about 98 weight percent of a low melt flow rate polymer having a melt flow rate less than about 20 grams per 10 minutes, and from about 1 to about 20 weight percent of nanoparticles. In one embodiment, the nanoparticles may be cylindrical nanoparticles having an average aspect ratio greater than about 1 and less than about 500. Composition percent amounts herein are expressed by weight of the total composition unless otherwise indicated.

Fiber-Forming or Film-Forming Polymer

Exemplary polymers for use as the fiber-forming or film-forming polymer of the thermoplastic composition may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the fiber-forming or film-forming polymer may also contain other additives, such as processing aids or treatment compositions to impart desired properties to the fibers, residual amounts of solvents, pigments or colorants, and so forth.

The fiber-forming or film-forming polymer can have a melt flow rating of greater than about 30 g/10 minutes at 230° C., such as from about 30 g/10 minutes to about 50 g/10 minutes at 230° C., and particularly from about 33 g/10 minutes to about 39 g/10 minutes at 230° C. In one embodiment, the fiber-forming or film-forming polymer contains a homopolymer of polypropylene. The fiber-forming or film-forming polymer can be a Ziegler-Natta catalyzed polymer or, alternatively, can be a metallocene catalyzed polymer. In one embodiment, the fiber-forming or film-forming polymer can be product number PP3155 marketed by the ExxonMobil Chemical Corporation, which is a polypropylene polymer having a melt flow rate at 230° C. of about 36 g/10 minutes.

The fiber-forming or film-forming polymer can be added to the thermoplastic composition in an amount of about 1% by weight to about 98% by weight, such as from about 50% by weight to about 90% by weight. In one particular embodiment, for instance, the fiber-forming or film-forming polymer can be added to the thermoplastic composition in an amount of about 60% by weight to about 90% by weight, or, for instance, in an amount of about 70% by weight to about 90% by weight.

High Molecular Weight/Low Melt Flow Polymer

Exemplary polymers for use as the high molecular weight/low melt flow polymer of the thermoplastic composition may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the high molecular weight/low melt flow polymer may also contain other additives, such as processing aids or treatment compositions to impart desired properties to the fibers, residual amounts of solvents, pigments or colorants, and so forth.

The high molecular weight/low melt flow rate polymer can have a melt flow rating of less than about 25 g/10 minutes at 230° C., such as from about 1 g/10 minutes to about 25 g/10 minutes at 230° C., and particularly from about 4 g/10 minutes to about 20 g/10 minutes at 230° C. In one embodiment, the high molecular weight/low melt flow rate polymer contains a homopolymer of polypropylene. The high molecular weight/low melt flow rate polymer can be a Ziegler-Natta catalyzed polymer or, alternatively, can be a metallocene catalyzed polymer. In one embodiment, the high molecular weight/low melt flow rate polymer can be product number 1052 marketed by the ExxonMobil Chemical Corporation, which is believed to be a polypropylene polymer having a melt flow rate at 230° C. of about 5.3 g/10 minutes. In another embodiment, the high molecular weight/low melt flow rate polymer can be product number 2252E4 marketed by the ExxonMobil Chemical Corporation, which is believed to be a polypropylene polymer having a melt flow rate at 230° C. of about 4.2 g/10 minutes. In a further embodiment, the high molecular weight/low melt flow rate polymer can be product number HM560P marketed by LyondellBasell, which is believed to be a polypropylene polymer having a melt flow rate at 230° C. of about 15 g/10 minutes.

The high molecular weight/low melt flow polymer can be added to the thermoplastic composition in an amount of about 1% by weight to about 98% by weight, such as from about 10% by weight to about 50% by weight. In one particular embodiment, for instance, the high molecular weight/low melt flow polymer can be added to the thermoplastic composition in an amount of about 10% by weight to about 35% by weight, or, for instance in an amount of about 10% by weight to about 25% by weight.

The high molecular weight/low melt flow polymers useful in the thermoplastic composition have molecular weights (high)/melt flow rates (low) that generally would be associated with causing processing problems in the process of making sheet materials. The inventors have discovered that the thermoplastic formulations of the present invention surprisingly mitigate those processing problems generally associated with the high molecular weight/low melt flow polymers. More surprisingly, it was discovered that inclusion of the nanoparticles in the thermoplastic composition reduced the viscosity such that the fiber forming process was improved as demonstrated by reduced numbers of fiber breaks and improved process stability.

Nanoparticles

According to the present invention, nanoparticles can be integrally incorporated into the thermoplastic composition. For example, the nanoparticles can be blended into the thermoplastic composition. The nanoparticles can be added to the thermoplastic composition in an amount of about 0.1% by weight to about 10% by weight, such as from about 0.2% by weight to about 5% by weight. In one particular embodiment, for instance, the nanoparticles can be added to the thermoplastic composition in an amount of about 0.25% by weight to about 2% by weight. In an even further embodiment, the nanoparticles can be added to the thermoplastic composition in an amount of about 0.25% by weight to about 1% by weight. Reducing the quantity of nanoparticles tends to reduce the tensile property improvement, but may improve processability of the thermoplastic composition by decreasing crystallization rates of the polymers.

Many materials may be used as nanoparticles in the present invention. As used herein, “nanoparticles” are particles which have an average diameter between about 10 and 200 nanometers, or in other embodiments between about 10 and 100 nanometers, and in selected embodiments have a width which is between about 20 and 150 nanometers, or in other embodiments between about 20 and 50 nanometers. The nanoparticles used in the present invention may have a variety of shapes and particle sizes. In some embodiments, the selection of a particular aspect ratio of the nanoparticles may provide benefits in both spinning and to the composite nanofiber. As used herein, “average aspect ratio” is the average width of a particle divided by its average length or range of lengths. In some embodiments, nanoparticles having an average aspect ratio of greater than one may be particularly suited for use in the present invention. In selected embodiments, nanoparticles having an average aspect ratio of from about 2 to about 200 would be useful in the present invention, although nanoparticles having an average aspect ratio outside of this range may also be useful in the present invention. In some embodiments, the nanoparticles may be cylindrical nanoparticles, i.e., having a generally cylindrical shape.

In general, materials such as silica, carbon, clay, mica, calcium carbonate, and other materials are suitable for use in the present invention. Selected metals and metal compounds and metal oxides may also be suitable for use in the present invention, such as, for example, Group IB-VIIB metals from the periodic table. Metal oxides such as manganese(II,III) oxide (Mn₃O₄), silver (I, III) oxide (AgO), copper(I) oxide (Cu₂O), silver(I) oxide (Ag₂O), copper (II) oxide (CuO), nickel (II) oxide (NiO), aluminum oxide (Al₂O₃), tungsten (II) oxide (W₂O₃), chromium(IV) oxide (CrO₂), manganese (IV) oxide (MnO₂), titanium dioxide (TiO₂), tungsten (IV) oxide (WO₂), vanadium (V) oxide (V₂O₅), chromium trioxide (CrO₃), manganese (VII) oxide, Mn₂O₇), osmium tetroxide (OsO₄) and the like may be useful in the present invention.

In some embodiments, the nanoparticles may be particles of cylindrically-shaped halloysite clay nanotubes. Halloysite clay nanotubes are a naturally occurring aluminosilicate nano particle having the following chemical formulation: Al₂Si₂O₅(OH)₄2H₂O. It is a two-layered aluminosilicate, with a predominantly hollow tubular structure in the submicron range. The neighboring alumina and silica layers naturally curve and form multilayer tubes. Halloysite is an economically advantaged material that can be mined from the deposit as a raw mineral. Chemically, the outer surface of the halloysite nanotubes has properties similar to SiO₂ while the inner lumen has properties similar to Al₂O₃. The charge (zeta potential) behavior of halloysite particles can be roughly described by superposition of the mostly negative (at pH 6-7) surface potential of SiO₂, with a small contribution from the positive Al₂O₃ inner surface. The positive (below pH 8.5) charge of the inner lumen enables the inner lumen of the nanotube to be loaded with negatively charged macromolecules, which are at the same time repelled from the negatively charged outer surfaces.

In some embodiments, the nanoparticles may be coated with a functionalized block copolymer for improving compatibility with the polymers in the thermoplastic composition. One block of the copolymer is selected to promote ionic bonding between the inorganic particles. The other block of the copolymer is selected for compatibility with the polymers in the thermoplastic composition. Such coatings are taught in U.S. Patent Application 2008/0200601 to Flores Santos et al., the contents of which are incorporated herein by reference thereto for all purposes.

In some embodiments of the present invention, the halloysite clay nanotubes may be aligned so that the longitudinal axis of at least a portion of the clay nanotubes is in approximate alignment with the longitudinal axis of the fiber. This alignment may provide enhanced mechanical properties to the composite fiber.

A wide range of active agents, including drugs, biocides and other substances can be positioned within the inner lumen of the nano tube. The retention and controlled release of active agents from the inner lumen makes the halloysite clay nano tubes well-suited for numerous delivery applications.

Suitable cylindrical nanoparticles include halloysite clay nanotubes having an average diameter of about seventy (70) nm and lengths ranging between about 500 to 2000 nm available from Macro-M (Lermo, EDO Mex). Other suitable cylindrical nanoparticles include halloysite clay nanotubes which available from Sigma-Aldrich (St. Louis, Mo.) having an average outer diameter of about thirty (30) nm and lengths ranging between about 500-4000 nm. The aspect ratios of the nano tubes may range from about 10 to about 133, although nanoparticles with other aspect ratios may also be utilized in the present invention.

In some embodiments, the nanoparticles can be provided in a carrier resin. The carrier resin may be configured to help blend the nanoparticles into the thermoplastic composition. For instance, the carrier resin polymer can have a melting temperature of greater than about 150° C., and particularly greater than about 155° C. Additionally, in order to facilitate the formation of sheet materials, particularly continuous filaments in a melt spinning operation, the carrier resin polymer can have a melt flow rating of greater than about 30 g/10 minutes, such as from about 30 g/10 minutes to about 50 g/10 minutes, and particularly from about 33 g/10 minutes to about 39 g/10 minutes. In one embodiment, the carrier resin contains a homopolymer of polypropylene. The polypropylene contained in the carrier resin can be a Ziegler-Natta catalyzed polymer or, alternatively, can be a metallocene catalyzed polymer. In one embodiment, the carrier resin polymer can be product number 3155 or 3854 marketed by the ExxonMobil Chemical Corporation, which is believes to be a polypropylene polymer having a melt flow rate of from 25 g/10 minutes to 39 g/10 minutes.

The nanoparticles can be mixed or blended with either the carrier resin or the high molecular weight/low melt flow polymer prior to being added to the thermoplastic composition. For example, the nanoparticles can be added to the carrier resin in an amount up to about 50% by weight, such as from about 5% to about 40% by weight. In one particular embodiment, the nanoparticles and the carrier resin can be blended such that the nanoparticles is present from about 10% to about 30% by weight, such as from about 15% to about 25% by weight. Then, the mixture of the nanoparticles and the carrier resin can be incorporated into the thermoplastic composition.

Sheet Materials

The thermoplastic composition of the present invention may be used to form various sheet materials from fibers, films, and so forth. As used herein, the term “fibers” refer to elongated extrudates formed by passing a polymer through a forming orifice such as a die. Unless noted otherwise, the term “fibers” includes discontinuous fibers having a definite length and substantially continuous filaments. Substantially continuous filaments may, for instance, have a length much greater than their diameter, such as a length to diameter ratio (“aspect ratio”) greater than about 15,000 to 1, and in some cases, greater than about 50,000 to 1.

The fibrous sheet material may be either a woven or a nonwoven sheet material. As used herein, the term “nonwoven sheet material” refers to a web having a structure of individual fibers that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

In one particular embodiment, for example, the fibrous sheet material is a spunbond web. As used herein, the term “spunbond” web or layer generally refers to a nonwoven web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond filaments are generally not tacky when they are deposited onto a collecting surface. Spunbond filaments may sometimes have diameters less than about 40 micrometers, and are often between about 5 to about 20 micrometers.

In another embodiment, the fibrous sheet material may be a meltblown web. As used herein, the term “meltblown” web or layer generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al.; U.S. Pat. No. 4,307,143 to Meitner, et al.; and U.S. Pat. No. 4,707,398 to Wisneski, et al., which are incorporated herein in their entirety by reference thereto for all purposes. Meltblown fibers may be substantially continuous or discontinuous, and are generally tacky when deposited onto a collecting surface.

The thermoplastic composition may be useful as one or more of the components in a multicomponent fiber used to make fibrous sheet materials. As used herein, the term “multicomponent” refers to fibers formed from at least two polymers or thermoplastic compositions (e.g., bicomponent fibers) that are extruded from separate extruders. The polymers or thermoplastic compositions are arranged in substantially constantly positioned distinct zones across the cross-section of the fibers. The components may be arranged in any desired configuration, such as sheath-core, side-by-side, pie, island-in-the-sea, and so forth. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

Although not required, the fibrous sheet material may be optionally bonded using any conventional technique, such as with an adhesive or autogenously (e.g., fusion and/or self-adhesion of the fibers without an applied external adhesive). Suitable autogenous bonding techniques may include ultrasonic bonding, thermal bonding, through-air bonding, calender bonding, and so forth. The temperature and pressure required may vary depending upon many factors including but not limited to, pattern bond area, polymer properties, fiber properties and sheet material properties. For example, the fibrous sheet material may be passed through a nip formed between two rolls, one which may be patterned. In this manner, pressure is exerted on the materials to bond them together. For example, the nip pressure may range from about 0.1 to about 100 pounds per linear inch, in some embodiments from about 1 to about 75 pounds per linear inch, and in some embodiments, from about 2 to about 50 pounds per linear inch. One or more of the rolls may likewise have a surface temperature of from about 15° C. to about 120° C., in some embodiments from about 20° C. to about 100° C., and in some embodiments, from about 25° C. to about 80° C.

To provide improved processability when forming sheet materials, the thermoplastic composition may have a melt flow rate within a certain range. More specifically, thermoplastic compositions having a low melt flow index, or conversely a high viscosity, are generally difficult to process. Thus, in most embodiments, such as for forming spunbond fibers, the melt flow rate of the thermoplastic composition is at least about 20 grams per 10 minutes, in some embodiments at least about 25 grams per 10 minutes, and in some embodiments, from about 30 to about 100 grams per 10 minutes. Of course, the melt flow rate of the thermoplastic composition will ultimately depend upon the selected forming process. For example, other melt flow rates may be appropriate for forming films or meltblown fibers.

Although the basis weight of the sheet materials of the present invention may be tailored to the desired application, it generally ranges from about 10 to about 300 grams per square meter (“gsm”), in some embodiments from about 25 to about 200 gsm, and in some embodiments, from about 40 to about 150 gsm.

Sheet materials formed from the thermoplastic composition of the present invention were found to have improved tensile properties compared to those of sheet materials made from 100% fiber-forming polymer.

In some embodiments, sheet materials formed from the thermoplastic composition of the present invention may show increases in strip tensile test GMT (measured as defined above) when compared to sheet materials formed from 100% fiber-forming polymer. For example, sheet materials formed from the thermoplastic composition of the present invention may have a geometric mean tensile property about 1% to about 50% higher than that of a similar sheet material formed from 100% fiber forming polymer, more particularly about 10 to about 45% higher than that of a similar sheet material formed from 100% fiber forming polymer, and even more particularly about 20 to about 40% higher than that of a similar sheet material formed from 100% fiber forming polymer.

In some embodiments, sheet materials formed from the thermoplastic composition of the present invention may show increases in machine direction strip tensile energy (measured as defined above) when compared to sheet materials formed from 100% fiber-forming polymer. For example, sheet materials formed from the thermoplastic composition of the present invention may have a machine direction strip tensile energy about 1 to about 175% higher than a similar sheet material formed from 100% fiber-forming polymer, more particularly about 10 to about 145% higher than a similar sheet material formed from 100% fiber-forming polymer, and even more particularly about 20 to about 100% higher than a similar sheet material formed from 100% fiber-forming-polymer.

In some embodiments, sheet materials formed from the thermoplastic composition of the present invention may show increases in cross direction strip tensile energy (measured as defined above) when compared to sheet materials formed from 100% fiber-forming polymer. For example, sheet materials formed from the thermoplastic composition of the present invention may have a cross direction strip tensile energy about 1 to about 215% higher than a similar sheet material formed from 100% fiber-forming polymer, more particularly about 10 to about 150% higher than a similar sheet material formed from 100% fiber-forming polymer, and even more particularly about 20 to about 100% higher than a similar sheet material formed from 100% fiber-forming polymer.

In some embodiments, sheet materials formed from the thermoplastic composition of the present invention may show increases in machine direction strip tensile elongation (measured as defined above) when compared to sheet materials formed from 100% fiber-forming polymer. For example, sheet materials formed from the thermoplastic composition of the present invention may have a machine direction strip tensile elongation about 1 to about 125% higher than a similar sheet material formed from 100% fiber-forming polymer, more particularly about 10 to about 100% higher than a similar sheet material formed from 100% fiber-forming polymer, and even more particularly about 20 to about 75% higher than a similar sheet material formed from 100% fiber-forming polymer.

In some embodiments, sheet materials formed from the thermoplastic composition of the present invention may show increases in cross direction strip tensile elongation (measured as defined above) when compared to sheet materials formed from 100% fiber-forming polymer. For example, sheet materials formed from the thermoplastic composition of the present invention may have a cross direction strip tensile elongation about 1 to about 122% higher than a similar sheet material formed from 100% fiber-forming polymer, more particularly about 10 to about 100% higher than a similar sheet material formed from 100% fiber-forming polymer, and even more particularly about 20 to about 75% higher than a similar sheet material formed from 100% fiber-forming polymer.

Products

The sheet materials of the present invention may be used in a wide variety of applications. For example, the sheet materials may be incorporated into a “medical product”, such as gowns, surgical drapes, facemasks, head coverings, surgical caps, shoe coverings, sterilization wraps, warming blankets, heating pads, and so forth. As other examples, the sheet materials may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art. Absorbent articles, for instance, typically include a substantially liquid-impermeable layer (e.g., outer cover), a liquid-permeable layer (e.g., bodyside liner, surge layer, etc.), and an absorbent core. In one embodiment, for example, the sheet material of the present invention may be used to form the body-side liner or a part of an outer cover of an absorbent article.

The present invention may be better understood with reference to the following examples.

### EXAMPLES

Various formulations of thermoplastic compositions were prepared as indicated in Table 1. The nanoparticles used in the examples was Halloysite clay nano tubes, coated as taught in U.S. Patent Application 2008/0200601 and having an average diameter of about fifty (50) nm and lengths which ranged between about 500 to 2000 nm (obtained from Macro-M (Lermo, EDO Mex)). Four polypropylene homopolymers were used at the various weight percentages shown in Table 1 to prepare the various thermoplastic compositions: PP3155 having a melt flow rate of 36 g/10 min (available from ExxonMobil Chemical Corporation), PP1052 having a melt flow rate of 5.3 g/10 min (available from ExxonMobil Chemical Corporation), PP2252E4 having a melt flow rate of 4.2 g/10 min (available from ExxonMobil Chemical Corporation, and HM560P having a melt flow rate of 15 g/10 min (available from LyondellBasell). The thermoplastic compositions were extruded by a spunbond process into fibers (about 2 denier per fiber) and made into spunbond fabrics as shown in Table 1. Codes 1-19 had basis weights of 0.45 ounces per square yard. Codes 20-38 had basis weights of 0.75 ounces per square yard. The samples were tested for tensile properties, and geometric mean tensile values were calculated as shown in Table 2. Code 1 was the control for Codes 2-19 and Code 20 was the control for Codes 21-28. Tensile property improvements on a percentage basis compared to the controls are shown in Table 3. It is noted that Codes 2, 8, 13, 21, 27, and 32 did not contain any nanoparticles and also did not process very well in that a large number of fiber breaks occurred during processing. For these codes, it was possible to obtain samples, but the process could not be run consistently without fiber breaks that would disrupt commercial production. For almost every other Code, tensile property improvements (peak load, GMT, elongation, and energy) are demonstrated over the control materials in both the machine direction and cross direction, and processing was consistent without fiber breaks. Only Code 26, considered to be an outlier, did not show tensile property improvements. This is not believed to be due to the formulation, though, but is believed to have been caused by some other process upset such as perhaps undetected improper process temperature settings.

TABLE 1

| | NanoClay | PP3155 | HM560P | PP1052 | PP2252E4 | Denier per |
|---|---|---|---|---|---|---|
| Code | (wt. %) | (wt. %) | (wt. %) | (wt. %) | (wt. %) | fiber |
| 1 | 0 | 100 | | | | 2.1 |
| 2 | 0 | 50 | 50 | | | 2.1 |
| 3 | 0.25 | 49.75 | 50 | | | 2 |
| 4 | 0.5 | 49.5 | 50 | | | 2 |
| 5 | 1 | 49 | 50 | | | 2.2 |
| 6 | 0.7 | 86.8 | 12.4 | | | 2 |
| 7 | 1.5 | 73.5 | 25 | | | 2 |
| 8 | 0 | 75 | | 25 | | 2 |
| 9 | 0.125 | 74.875 | | 25 | | 2.1 |
| 10 | 0.25 | 74.75 | | 25 | | 2.1 |
| 11 | 0.5 | 74.5 | | 25 | | 2.1 |
| 12 | 1.5 | 73.5 | | 25 | | 2.3 |
| 13 | 0 | 75 | | | 25 | 2 |
| 14 | 0.125 | 74.875 | | | 25 | 2 |
| 15 | 0.25 | 74.75 | | | 25 | 2 |
| 16 | 0.5 | 74.5 | | | 25 | 2.1 |
| 17 | 1.5 | 73.5 | | | 25 | 2.1 |
| 18 | 1 | | 99 | | | 2 |
| 19 | 2 | 98 | | | | 2.2 |
| 20 | 0 | 100 | | | | 2.1 |
| 21 | 0 | 50 | 50 | | | 2.1 |
| 22 | 0.25 | 49.75 | 50 | | | 2 |
| 23 | 0.5 | 49.5 | 50 | | | 2 |
| 24 | 1 | 49 | 50 | | | 2.2 |
| 25 | 1.5 | 73.5 | 25 | | | 2 |
| 26 | 0.7 | 86.8 | 12.4 | | | 2 |
| 27 | 0 | 75 | | 25 | | 2 |
| 28 | 0.125 | 74.875 | | 25 | | 2.1 |
| 29 | 0.25 | 74.75 | | 25 | | 2.1 |
| 30 | 0.5 | 74.5 | | 25 | | 2.1 |
| 31 | 1.5 | 73.5 | | 25 | | 2.3 |
| 32 | 0 | 75 | | | 25 | 2 |
| 33 | 0.125 | 74.875 | | | 25 | 2 |
| 34 | 0.25 | 74.75 | | | 25 | 2 |
| 35 | 0.5 | 74.5 | | | 25 | 2.1 |
| 36 | 1.5 | 73.5 | | | 25 | 2.1 |
| 37 | 1 | | 99 | | | 2 |
| 38 | 2 | 98 | | | | 2.2 |

TABLE 2
Tensile Properties

| | CD- | CD | CD | MD | MD | MD | |
|---|---|---|---|---|---|---|---|
| Code | Load | Elong | Energy | Load | Elong | Energy | GMT |
| 1 | 1945 | 67 | 6118 | 4549 | 39 | 9699 | 2975 |
| 2 | 2381 | 79 | 9123 | 6260 | 58 | 20687 | 3861 |
| 3 | 2901 | 75 | 10524 | 5706 | 51 | 16438 | 4069 |
| 4 | 2877 | 81 | 11247 | 6059 | 62 | 21022 | 4175 |
| 5 | 2497 | 79 | 9546 | 6040 | 54 | 17831 | 3883 |
| 6 | 2298 | 70 | 7669 | 6475 | 54 | 19604 | 3857 |
| 7 | 2124 | 67 | 6978 | 5909 | 55 | 17899 | 3543 |
| 8 | 2752 | 107 | 14854 | 5697 | 73 | 23512 | 3960 |
| 9 | 2723 | 107 | 14479 | 5149 | 77 | 22824 | 3745 |
| 10 | 2870 | 96 | 14016 | 5067 | 67 | 19398 | 3813 |
| 11 | 2424 | 93 | 11419 | 5152 | 77 | 23011 | 3534 |
| 12 | 2843 | 107 | 15943 | 5172 | 88 | 26430 | 3835 |
| 13 | 2622 | 96 | 12641 | 5327 | 74 | 22480 | 3738 |
| 14 | 2882 | 85 | 12219 | 5341 | 68 | 20466 | 3923 |
| 15 | 2594 | 89 | 11350 | 5716 | 71 | 22766 | 3851 |
| 16 | 2478 | 75 | 9323 | 4874 | 72 | 19864 | 3475 |
| 17 | 2708 | 105 | 14068 | 5426 | 75 | 23001 | 3834 |
| 18 | 2283 | 72 | 7916 | 4516 | 43 | 10315 | 3211 |
| 19 | 2286 | 78 | 8400 | 6272 | 54 | 18696 | 3787 |
| 20 | 4173 | 52 | 10681 | 8365 | 45 | 21204 | 5909 |
| 21 | 5100 | 66 | 17340 | 9113 | 56 | 29780 | 6817 |
| 22 | 4663 | 68 | 16084 | 10795 | 54 | 33122 | 7095 |
| 23 | 4986 | 70 | 17785 | 9186 | 52 | 27485 | 6768 |
| 24 | 4877 | 68 | 16550 | 8839 | 48 | 23762 | 6566 |
| 25 | 4521 | 60 | 13961 | 8598 | 51 | 25723 | 6235 |
| 26 | 4040 | 53 | 11261 | 8374 | 49 | 23912 | 5816 |
| 27 | 4617 | 64 | 15128 | 9158 | 51 | 26801 | 6503 |
| 28 | 4827 | 102 | 26028 | 9385 | 75 | 41121 | 6731 |
| 29 | 4777 | 108 | 27265 | 9441 | 79 | 45179 | 6716 |
| 30 | 4932 | 94 | 24446 | 8223 | 85 | 41580 | 6369 |
| 31 | 5295 | 115 | 33389 | 8555 | 67 | 34539 | 6730 |
| 32 | 4857 | 98 | 24901 | 8926 | 75 | 39056 | 6584 |
| 33 | 4381 | 88 | 19703 | 8782 | 74 | 37865 | 6203 |
| 34 | 4627 | 87 | 21270 | 9239 | 67 | 36310 | 6538 |
| 35 | 4768 | 104 | 25414 | 8922 | 73 | 37722 | 6522 |
| 36 | 4718 | 101 | 24334 | 10160 | 76 | 45158 | 6924 |
| 37 | 4550 | 64 | 14440 | 8197 | 50 | 22858 | 6107 |
| 38 | 3957 | 74 | 14604 | 9719 | 59 | 33268 | 6202 |

TABLE 3
Tensile Properties % Change compared to control code

| | CD- | CD | CD | MD | MD | MD | |
|---|---|---|---|---|---|---|---|
| Code | Load | Elong | Energy | Load | Elong | Energy | GMT |
| 1 | 0.0% | 0.0% | 0.0% | 0.0% | 0.0% | 0.0% | 0.0% |
| 2 | 22.4% | 17.0% | 49.1% | 37.6% | 47.9% | 113.3% | 29.8% |
| 3 | 49.1% | 11.9% | 72.0% | 25.4% | 30.7% | 69.5% | 36.8% |
| 4 | 47.9% | 20.6% | 83.8% | 33.2% | 56.3% | 116.8% | 40.4% |
| 5 | 28.3% | 17.8% | 56.0% | 32.8% | 36.8% | 83.9% | 30.6% |
| 6 | 18.1% | 4.4% | 25.4% | 42.3% | 37.8% | 102.1% | 29.7% |
| 7 | 9.2% | −0.5% | 14.1% | 29.9% | 39.5% | 84.6% | 19.1% |
| 8 | 41.5% | 59.1% | 142.8% | 25.2% | 84.6% | 142.4% | 33.1% |
| 9 | 40.0% | 58.3% | 136.7% | 13.2% | 96.8% | 135.3% | 25.9% |
| 10 | 47.5% | 42.6% | 129.1% | 11.4% | 70.0% | 100.0% | 28.2% |
| 11 | 24.6% | 38.4% | 86.7% | 13.3% | 95.7% | 137.3% | 18.8% |
| 12 | 46.2% | 58.5% | 160.6% | 13.7% | 124.7% | 172.5% | 28.9% |
| 13 | 34.8% | 43.1% | 106.6% | 17.1% | 88.1% | 131.8% | 25.6% |
| 14 | 48.1% | 26.8% | 99.7% | 17.4% | 72.9% | 111.0% | 31.9% |
| 15 | 33.4% | 31.8% | 85.5% | 25.7% | 79.1% | 134.7% | 29.5% |
| 16 | 27.4% | 11.6% | 52.4% | 7.2% | 82.8% | 104.8% | 16.8% |
| 17 | 39.2% | 56.0% | 130.0% | 19.3% | 90.1% | 137.2% | 28.9% |
| 18 | 17.4% | 7.5% | 29.4% | −0.7% | 9.6% | 6.4% | 7.9% |
| 19 | 17.5% | 15.2% | 37.3% | 37.9% | 36.7% | 92.8% | 27.3% |
| 20 | 0.0% | 0.0% | 0.0% | 0.0% | 0.0% | 0.0% | 0.0% |
| 21 | 22.2% | 26.3% | 62.3% | 8.9% | 23.6% | 40.4% | 15.4% |
| 22 | 11.7% | 31.0% | 50.6% | 29.0% | 19.3% | 56.2% | 20.1% |
| 23 | 19.5% | 34.3% | 66.5% | 9.8% | 15.1% | 29.6% | 14.5% |
| 24 | 16.9% | 30.6% | 55.0% | 5.7% | 6.5% | 12.1% | 11.1% |
| 25 | 8.3% | 14.6% | 30.7% | 2.8% | 13.5% | 21.3% | 5.5% |
| 26 | −3.2% | 1.3% | 5.4% | 0.1% | 8.9% | 12.8% | −1.6% |
| 27 | 10.6% | 22.4% | 41.6% | 9.5% | 12.6% | 26.4% | 10.1% |
| 28 | 15.7% | 96.0% | 143.7% | 12.2% | 65.6% | 93.9% | 13.9% |
| 29 | 14.5% | 106.9% | 155.3% | 12.9% | 75.6% | 113.1% | 13.7% |
| 30 | 18.2% | 80.3% | 128.9% | −1.7% | 88.6% | 96.1% | 7.8% |
| 31 | 26.9% | 121.3% | 212.6% | 2.3% | 49.1% | 62.9% | 13.9% |
| 32 | 16.4% | 88.7% | 133.1% | 6.7% | 65.9% | 84.2% | 11.4% |
| 33 | 5.0% | 70.0% | 84.5% | 5.0% | 64.2% | 78.6% | 5.0% |
| 34 | 10.9% | 67.1% | 99.1% | 10.4% | 48.7% | 71.2% | 10.7% |
| 35 | 14.2% | 99.3% | 137.9% | 6.7% | 61.1% | 77.9% | 10.4% |
| 36 | 13.0% | 94.6% | 127.8% | 21.5% | 69.3% | 113.0% | 17.2% |
| 37 | 9.0% | 23.8% | 35.2% | −2.0% | 10.4% | 7.8% | 3.4% |
| 38 | −5.2% | 43.1% | 36.7% | 16.2% | 31.8% | 56.9% | 5.0% |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto. As used herein, the term “comprising” is inclusive or open-ended and does not exclude additional unrecited elements, compositional components, or method steps. In addition, it should be noted that any given range presented herein is intended to include any and all lesser included ranges. For example, a range of from 45-90 would also include 50-90; 45-80; 46-89 and the like.

1.-6. (canceled)

7. A fibrous web comprising a thermoplastic composition suitable for forming fibers, the thermoplastic composition comprising:
from about 1 to about 98 weight percent of a fiber-forming or film-forming polymer having a melt flow rate from about 30 grams per 10 minutes to about 50 grams per 10 minutes, the fiber-forming or film-forming polymer comprising a polyolefin;
from about 1 to about 98 weight percent of a low melt flow rate polymer having a melt flow rate less than 20 grams per 10 minutes, the low melt flow rate polymer comprising a polyolefin and having a higher molecular weight than the fiber-forming or film-forming polymer; and
from about 0.1 to about 5 weight percent of nanoparticles, the nanoparticles being present in the thermoplastic composition in an amount sufficient to reduce the viscosity of the composition during formation of the fibrous web.

8. The fibrous web of claim 7, wherein the nanoparticles have an average aspect ratio great than one.

9. The fibrous web of claim 7, wherein the nanoparticles have an average aspect ratio less than 500.

10. The fibrous web of claim 7, the nanoparticles being cylindrical nanoparticles.

11. The fibrous web of claim 7, the fibrous web having a geometric mean tensile property about 1% to about 50% higher than that of a similar fibrous web formed from 100% fiber forming polymer.

12. The fibrous web of claim 7, the nanoparticles being clay nanoparticles.

13. The fibrous web of claim 12, the nanoparticles being halloysite clay nanotubes.

14. (canceled)

15. A film comprising a thermoplastic composition suitable for forming fibers, the thermoplastic composition comprising:
from about 1 to about 98 weight percent of a fiber-forming or film-forming polymer having a melt flow rate from about 30 grams per 10 minutes to about 50 grams per 10 minutes, the fiber-forming or film-forming polymer comprising a polyolefin;
from about 1 to about 98 weight percent of a low melt flow rate polymer having a melt flow rate less than 20 grams per 10 minutes, the low melt flow rate polymer comprising a polyolefin and having a higher molecular weight than the fiber-forming or film-forming polymer; and
from about 0.1 to about 5 weight percent of nanoparticles, the nanoparticles being present in the thermoplastic composition in an amount sufficient to reduce the viscosity of the composition during formation of the film.

16. The film of claim 15, the nanoparticles being selected from the group consisting of metals, metal compounds, ceramics and clays.

17. The film of claim 15, wherein the nanoparticles have an average aspect ratio greater than one and less than 500.

18. The film of claim 15, wherein at least a portion of the nanoparticles are cylindrical nanoparticles.

19. The film of claim 15, wherein at least a portion of the nanoparticles are halloysite clay nanotubes.

20. (canceled)

21. The fibrous web of claim 7, wherein the fiber-forming or film-forming polymer comprises polypropylene and wherein the low melt flow rate polymer comprises polypropylene.

22. The fibrous web of claim 7, wherein at least one of the fiber-forming or film-forming polymer or the low melt flow rate polymer comprises polypropylene.

23. The fibrous web of claim 7, wherein the nanoparticles are present in the thermoplastic composition in an amount from about 0.1% to about 2% by weight.

24. The fibrous web of claim 7, wherein the fiber-forming or film-forming polymer is present in the thermoplastic composition in an amount from about 60% to about 90% by weight, and wherein the low melt flow rate polymer is present in the thermoplastic composition in an amount from about 10% to about 35% by weight.

25. The fibrous web of claim 15, wherein the fiber-forming or film-forming polymer comprises polypropylene and wherein the low melt flow rate polymer comprises polypropylene.

26. The fibrous web of claim 15, wherein at least one of the fiber-forming or film-forming polymer or the low melt flow rate polymer comprises polypropylene.

27. The fibrous web of claim 15, wherein the nanoparticles are present in the thermoplastic composition in an amount from about 0.1% to about 2% by weight.

28. The fibrous web of claim 15, wherein the fiber-forming or film-forming polymer is present in the thermoplastic composition in an amount from about 60% to about 90% by weight, and wherein the low melt flow rate polymer is present in the thermoplastic composition in an amount from about 10% to about 35% by weight.
